(19) United States
(12) Patent Application Publication
(10) Pub. No.: US 2008/0123138 A1
(43) Pub. Date: May 29, 2008

(54) Image Fit To Media Area Method

(76) Inventors: Joy Banerjee, Kolkata (IN); Terrance Lee Druggan, Lexington, KY (US); William Roger Steen, Lexington, KY (US)

Correspondence Address: John Victor Pezdek;Lexmark International, Inc., Intellectual Property Department, 740 West New Circle Road, Lexington, KY, 40550, US

(21) Appl. No.: 11/564,359

(22) Filed: Nov. 29, 2006

(51) Int. Cl. G06K 15/00

(52) U.S. Cl. 358/1.18

(57) ABSTRACT

Images may be arranged in a minimal number of media areas through a recurring process of positioning an image within a white space of the media area and subdividing the white space into an image space in which the image is positioned, a second white space, and a third white space. The second white space occupies a region of the first white space not occupied by the first image along a first direction while the third white space occupies a region of the first white space not occupied by the image along a second direction. Then, subsequent images may be positioned within the unoccupied white spaces if the images spatially fit in one of an original or rotated orientation. As images are placed into unoccupied white spaces, the white spaces may be further subdivided.

### BACKGROUND

Conventionally, photo packages obtained retail photo services, such as photography studios or student school photos, include one or more photos of various sizes printed on a standard media area, such as an 8½×11 printed page. Often, in selecting photo packages, consumers are limited to choices of a predetermined number of photos of a particular size. This predetermined number is often based on the total number of images of that size that will fit in the standard media area. Consequently, consumers are often forced to purchase additional unwanted photos because the desired number of photos does not perfectly match the predetermined number of available package photos.

Recent developments in digital photography have changed the landscape of photo handling, storage, processing, and printing. For example, many consumers are using the Internet to share and store digital photos that are acquired on a digital camera, digital scanner, or from the Internet. In many cases, consumers are electing to print their own digital photos. Often, consumer software provides home users the flexibility of printing desired sizes and quantities of photos. Unfortunately, in printing multiple sizes, images may not be arranged efficiently within printed media areas, resulting in wasted media.

### SUMMARY

Embodiments of the present invention are directed to a model for efficiently arranging images within one or more media areas. In one embodiment, the media areas may comprise printed pages. Images may be arranged in a minimal number of media areas through a recurring process of positioning an image within a white space of the media area and subdividing the white space into an image space in which the image is positioned, a second white space, and a third white space. The second white space occupies a region of the first white space not occupied by the first image along a first direction while the third white space occupies a region of the first white space not occupied by the image along a second direction. Then, subsequent images may be positioned within the unoccupied white spaces if the images spatially fit in one of an original or rotated orientation. As images are placed into unoccupied white spaces, the white spaces may be further subdivided. If an image does not fit within unoccupied white spaces of a first media area, a second media area may be created for the image. Subsequent images may be placed in the unoccupied white spaces of the first media area if the images fit in either of an original or rotated orientation. Additional optimization may be achieved by sorting the plurality of images into different image sets using different ordering schemes. Each set may be arranged in sequence into one or more media areas. Then, the ordering scheme that results in fewer total media areas may be selected for arranging the plurality of images into a minimum number of media areas.

### BRIEF DESCRIPTION OF THE DRAWINGS

FIG. 1 is a functional block diagram of a computer system on which the image arranging program may be implemented according to one embodiment;

FIG. 2 is a block diagram illustrating various functional components of the exemplary computing system from FIG. 1;

FIG. 3 is a schematic diagram illustrating one example of a graphical user interface for selecting sizes and quantities of images to be printed;

FIG. 4 is a schematic diagram illustrating a process of arranging multiple images into a minimal number of media areas according to one embodiment;

FIG. 5 is a schematic diagram illustrating multiple ordering schemes applicable in arranging multiple images into a minimal number of media areas according to one embodiment;

FIG. 6 is a schematic diagram illustrating a first image placement in a process of arranging multiple images into a minimal number of media areas according to one embodiment;

FIGS. 7A-D are schematic diagrams illustrating techniques for subdividing a media area according to one or more embodiments;

FIG. 8 is a flow diagram illustrating a technique for arranging multiple images into a minimal number of media areas according to one embodiment;

FIGS. 9-11 are schematic diagrams illustrating image placement steps in a process of arranging multiple images into a minimal number of media areas according to one embodiment; and

FIG. 12 is a flow diagram illustrating a technique for arranging multiple images into a minimal number of media areas according to one embodiment.

### DETAILED DESCRIPTION

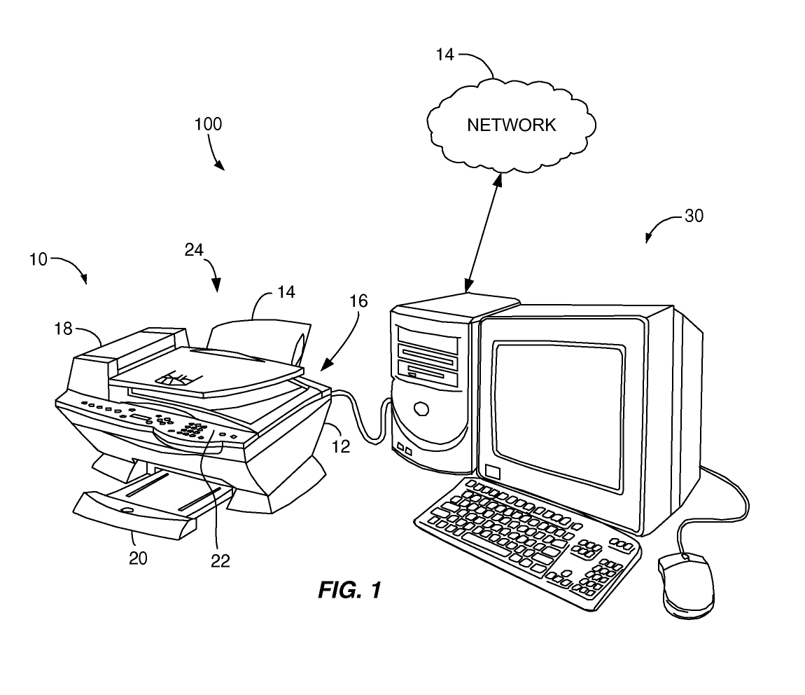

The various embodiments disclosed herein are directed to a model for arranging images within a media area in a manner that minimizes wasted media space. Generally, the images are placed into an available media area, either in Landscape or Portrait orientation. If an image does not fit into an available empty space on a media area, a new media area is created the insertion process repeats for that new area. One application where this model may be appropriate is for printing multiple images having a variety of sizes. For example, a user may wish to print images at home, school, or work using a conventional computer and printer. FIG. 1 depicts a computing system 100 comprising one embodiment of a representative printer, such as an All-In-One (AIO) device, indicated generally by the numeral 10 and a computer, indicated generally by the numeral 30. A multifunction printer 10 is shown, but other image forming devices, including laser printers, ink-jet printers, and photo printers are also contemplated. In the embodiment shown, the multifunction device 10 comprises a main body 12, a printer engine 24 with associated media trays 14, 20, a flatbed (or feed-through as known in the art) scanner 16 comprising a document handler 18, and a user interface panel 22. The multifunction device 10 is adapted to perform multiple home or business office functions such as printing, faxing, scanning, and copying. Consequently, the multifunction device 10 includes further internal components not visible in the exterior view shown in FIG. 1. The multifunction device 10 may be a local printer or a network printer disposed within a local area network or a remote printer disposed within a wide area network.

In FIG. 1, a desktop computer 30 is shown, but other conventional computers, including laptop and handheld computers are also contemplated. The image arranging process may be performed automatically or under the control of a user working on the computer 30. A user may wish to print images obtained locally, such as from the multifunction device 10 or computer 30, or images available from a network 14 such as the Internet.

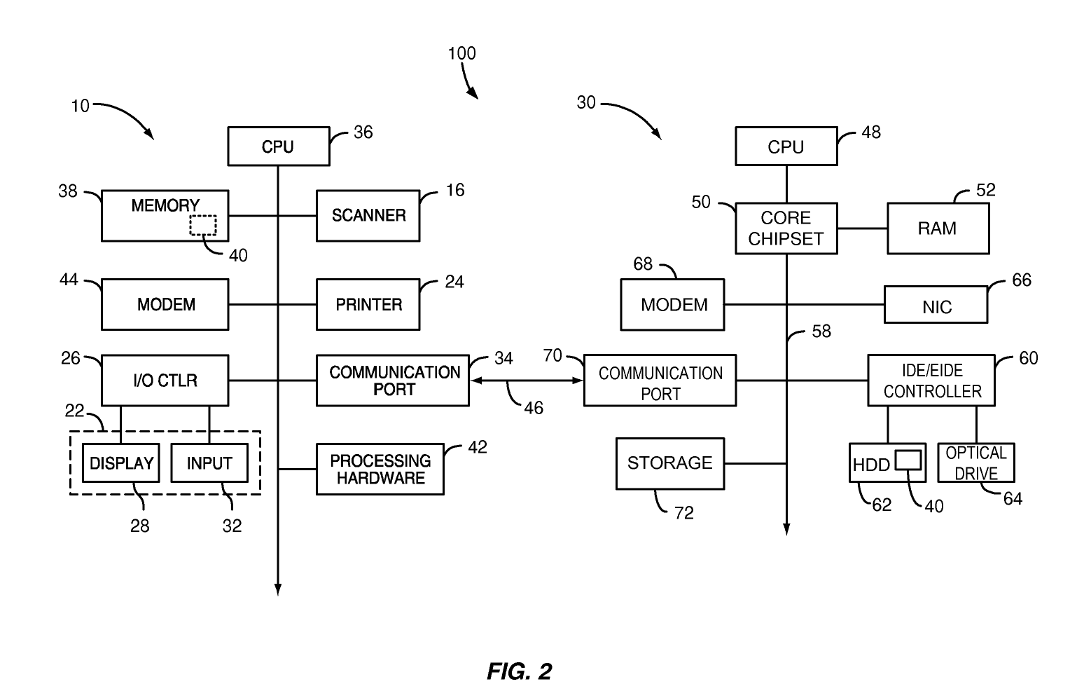

With regards to the image arranging techniques disclosed herein, certain embodiments may be performed by a software program that is stored locally and executable on the exemplary multifunction device 10 or computer 30. Accordingly, the relationship between the stored program and the processing components within the multifunction device 10 and the computer 30 is more clearly shown in the functional block diagram provided in FIG. 2. Specifically, FIG. 2 provides a simplified representation of some of the various functional components of the exemplary computing system 100, including the multifunction device 10 and computer 30. For instance, the multifunction device 10 includes a scanner 16 and an integrated printer 24, which may itself include a conventionally known ink jet or laser printer with a suitable document transport mechanism. Interaction at the user interface 22 is controlled with the aid of an I/O controller 26. Thus, the I/O controller 26 generates user-readable graphics at a display 28 and interprets commands entered at an input 32. The display 28 may be embodied as an alphanumeric LCD display and input 32 may be an alphanumeric keypad. Alternatively, the display 28 and input 32 functions may be accomplished with a composite touch screen (not shown) that simultaneously displays relevant information, including images, while accepting user input commands by finger touch or with the use of a stylus pen (not shown).

The exemplary embodiment of the multifunction device 10 also includes a modem 44, which may be a fax modem compliant with commonly used ITU and CCITT compression and communication standards such as the ITU-T series V recommendations and Class 1-4 standards known by those skilled in the art. The multifunction device 10 may also be coupled to the computer 30 with an interface cable 46 coupled through a compatible communication port 34, which may comprise a standard parallel printer port or a serial data interface such as USB 1.1, USB 2.0, IEEE-1394 (including, but not limited to 1394a and 1394b) and the like.

The multifunction device 10 may also include integrated wired or wireless network interfaces. Therefore, communication port 34 may represent a network interface, which permits operation of the multifunction device 10 as a stand-alone device not expressly requiring a host computer 30 to perform many of the included functions. A wired communication port 34 may comprise a conventionally known RJ-45 connector for connection to a 10/100 LAN or a 1/10 Gigabit Ethernet network. A wireless communication port 34 may comprise an adapter capable of wireless communications with other devices in a peer mode or with a wireless network in an infrastructure mode. Accordingly, the wireless communication port 34 may comprise an adapter conforming to wireless communication standards such as Bluetooth®, 802.11x, 802.15 or other standards known to those skilled in the art. A wireless communication protocol such as these may obviate the need for a physical cable link between the multifunction device 10 and the host computer 30.

The multifunction device 10 may also include one or more processing circuits 36, system memory 38, which generically encompasses RAM and/or ROM for system operation and code storage as represented by numeral 40. The system memory 38 may suitably comprise a variety of devices known to those skilled in the art such as SDRAM, DDRAM, EEPROM, Flash Memory, and perhaps a fixed hard drive. Those skilled in the art will appreciate and comprehend the advantages and disadvantages of the various memory types for a given application.

Additionally, the multifunction device 10 may include dedicated processing hardware 42, which may be a separate hardware circuit, or may be included as part of other processing hardware. For example, the image extraction techniques may be implemented via stored program instructions for execution by one or more Digital Signal Processors (DSPs), ASICs or other digital processing circuits included in the processing hardware 42. Alternatively, stored program code 40 may be stored in memory 38, with the image arranging model described herein executed by some combination of processor 36 and processing hardware 42, which may include programmed logic devices such as PLDs and FPGAs. In general, those skilled in the art will comprehend the various combinations of software, firmware, and hardware that may be used to implement the various embodiments described herein.

FIG. 2 also shows functional components of the exemplary computer 30, which comprises a central processing unit (“CPU”) 48, core logic chipset 50, and system random access memory (“RAM”) 52. The single CPU block 48 may be implemented as a plurality of CPUs 48 in a symmetric or asymmetric multi-processor configuration. Other illustrated components are coupled to the core chipset 50 through a communications bus 58, such as a PCI bus or PCI-X bus. For example, an IDE/EIDE/ASA controller 60 is connected to the core logic chipset 50 through the bus 58. A hard disk drive 62 and an optical drive 64 are coupled to the controller 60. Also connected to the bus 58 are a network interface card (“NIC”) 66, such as an Ethernet card, a modem 68, and a communication port 70. A storage device 72, such as a floppy drive, flash USB drive, media reader, external hard drive, or storage in a storage area network, may be coupled to the computer 30 as well.

The communication port 70 may include a complementary adapter conforming to the same or similar protocol as communication port 34 on the multifunction device 10. For example, each of the communication ports 34, 70 may be implemented as a USB or IEEE 1394 adapter. As discussed above, a one- or two-way communication link may be established between the computer 30 and the multifunction device 10 or other printing device through a cable interface indicated by line 46 in FIG. 2. Alternatively, the communication port 70 may comprise an adapter conforming to wireless communication standards as described above. Accordingly, the computer 30 and multifunction device 10 may be coupled through a wireless communications link 46.

Relevant to the techniques disclosed herein, images may be extracted from a remote location that is accessible through a number of portals in the computing system 100 shown. For example, local and remote networks such as the Internet may be accessible through the NIC 66, modem 68, or a wireless communications port 70. Alternatively, a database of images may be stored on fixed or portable media and accessible from the HDD 62, optical drive 64, storage 72, or accessed from a network by NIC 66 or modem 68. Further, the various embodiments of the image arranging techniques may be implemented in a device driver, browser plug-in, stand alone program, web-based script, or other software that is stored in memory 52, on HDD 62, on optical discs readable by optical disc drive 64, storage 72, or from a network accessible by NIC 66 or modem 68. Some or the entire image arranging program may be implemented through a microprocessor, including DSP and ASIC devices, executing embedded instructions or high powered logic devices such as VLSI, FPGA, and other CPLD devices. Those skilled in the art of computers and network architectures will comprehend additional structures and methods of implementing the techniques disclosed herein. For purposes of the following discussion, the image arranging program 40 is implemented as a computer program stored on a local hard disk drive 62 and executable by CPU 48. Those skilled in the art will comprehend other platforms for implementing the image arranging program 40.

As mentioned above, the image arranging program 40 defines a model for arranging images on within a predetermined media area that minimizes empty space. The image arranging program 40 may be used in conjunction with image printing software or other image handing software that provides users a method of arranging images within a media area. In one implementation, a variety of images with different sizes may be arranged in a manner that minimizes white space on hardcopy printed media sheets (e.g., 8½×11 or A4). In another implementation, the images may be arranged in a manner that minimizes white space on a softcopy media sheet (e.g., a PDF file, a presentation sheet, electronic brochure, etc). Accordingly, the area in which the images are arranged is referred to herein as a media area and is not intended to be limited to hardcopy or softcopy media sheets or pages.

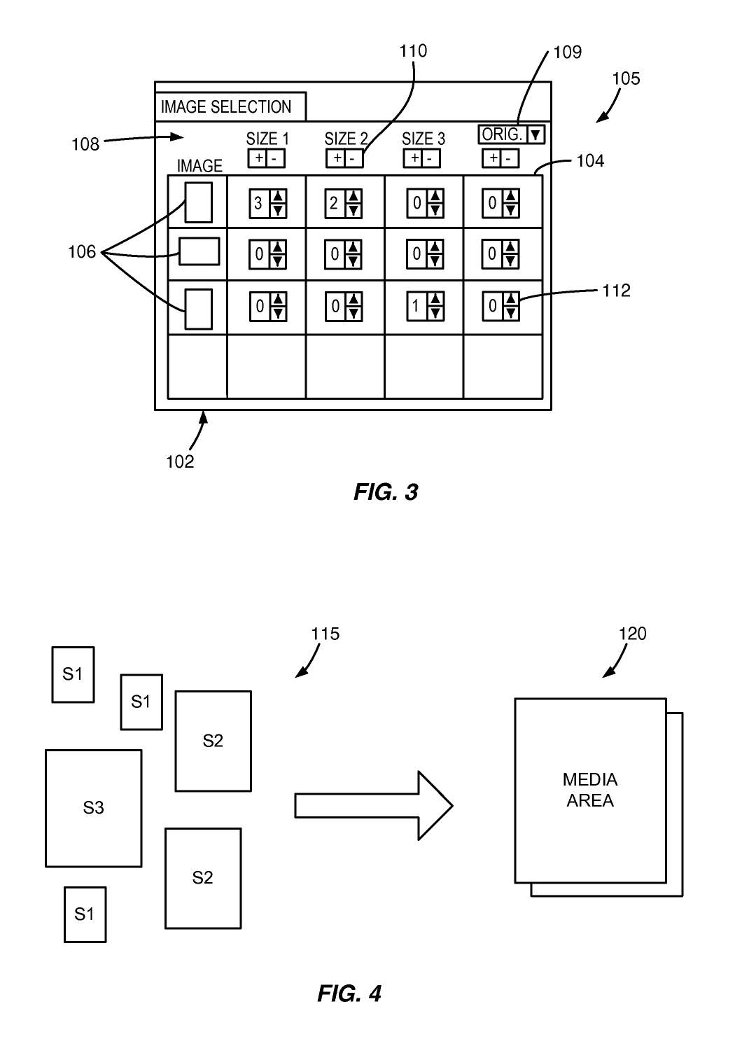

In an exemplary embodiment, the image arranging program 40 may be used in conjunction with printing software that allows users to select sizes and quantities of images to be printed. FIG. 3 illustrates one example of a graphical user interface (GUI) 105 that offers users the flexibility of selecting sizes and quantities of images to be printed. The representative GUI 105 presents an array of size and quantity options for images that are displayed on a left column 102 of a selection matrix 104. The images in the left column 102 may be represented by thumbnail representations 106 of high resolution images as are known in the art. The left column 102 simply presents a visual representation of the image that will be printed. If there are too many photos to view at one time, a scrollbar may be used to view additional images.

Column headers 108 display different specific print sizes. An additional column may include a dropdown tool 109 providing users an option to select different print sizes, including an original print size based on the native resolution of the image. The specific print size columns may be specific to geographical areas. For instance, the columns may include the most popular print sizes in the region (e.g., 4×6, 5×7, 8×10 in the USA). Different countries may include different size columns. At each column, a+ or − link 110 under each print size will increment or decrement that print size for all photos in the left column 102. Additional flexibility is provided at the intersection 112 of each size and image allowing users to select individual quantities of prints for a given image. Notably, the GUI 105 presented in FIG. 3 illustrates one particular example of an image selection tool. Other tools known and conceivable by those skilled in the art may be used.

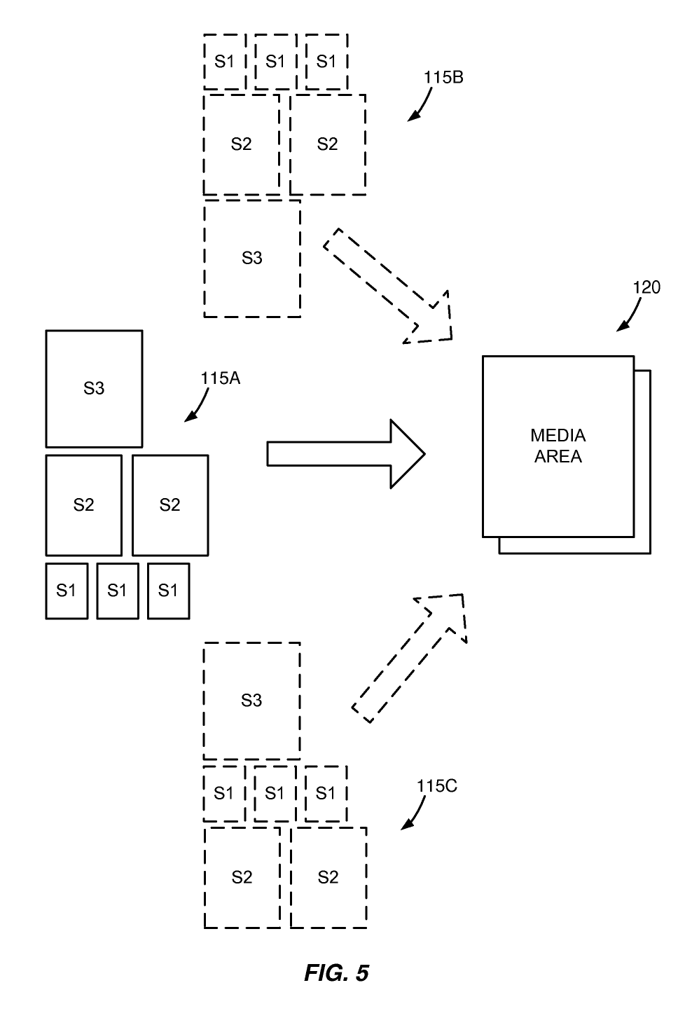

FIG. 4 illustrates a variety of images 115 selected using a tool such as that shown in FIG. 3. These images 115 are then arranged using the image arranging program 40 to fit within a minimal number of media areas 120. In the illustrated example, a group of six images 115 are to be arranged in an optimized manner on media areas 120. Three of the images 115 are labeled S1 representing a first, small image size. Two images 115 are labeled S2 representing a second, intermediate image size. Lastly, one image 115 is labeled S3 representing a third, large image size.

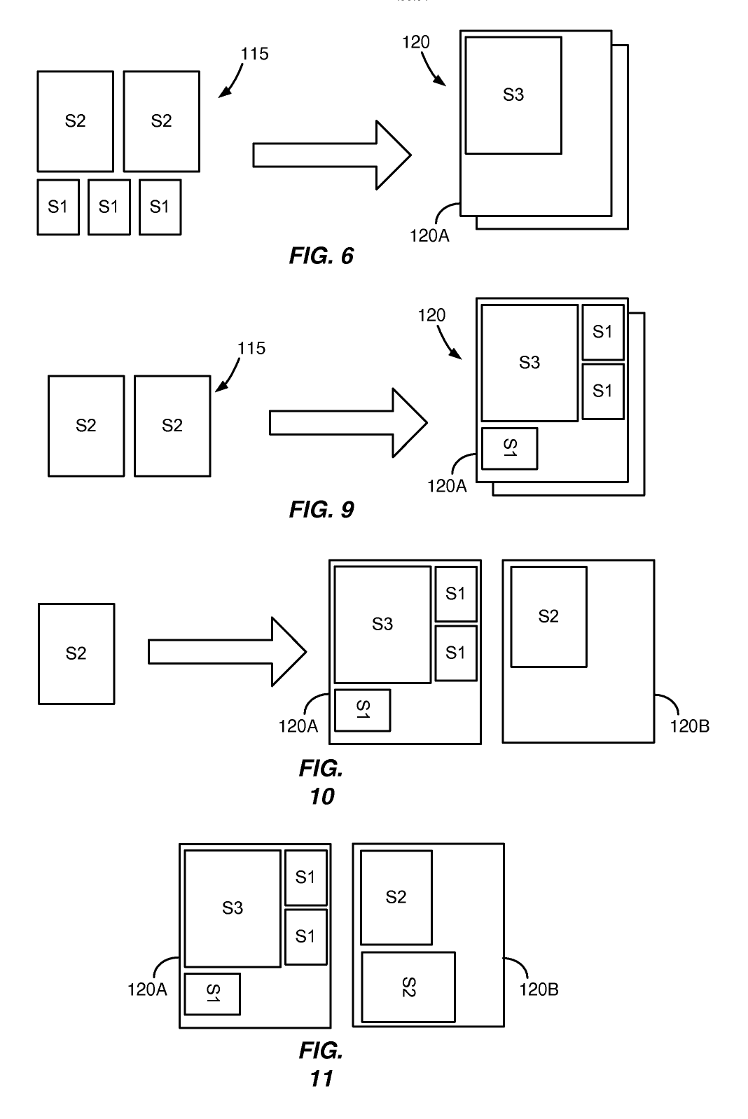

Prior to arranging the images 115 within the media areas 120, the images are arranged by size. FIG. 5 illustrates some exemplary approaches that may be used to arrange the images 115. The solid line representation of the images 115A depicts an arrangement where the images are sequentially arranged in order of decreasing image size. Thus, the largest image S3 is shown first while the smallest images S1 are shown last. Those skilled in the art will comprehend a variety of methods for arranging the images in this manner, including but not limited to a temporary listing of image names and sizes stored in memory 38, 52.

FIG. 5 also shows two alternative dashed-line representations 115B, 115C depicting different arranging techniques. The upper dashed-line representation 115B depicts an arrangement where the images are sequentially arranged in order of increasing image size. Thus, the largest image S3 is shown last while the smallest images S1 are shown first. By comparison, the lower dashed-line representation 115C depicts an arrangement where the images are sequentially arranged in order of alternating image sizes. Thus, the largest image S3 is shown first while the smallest images S1 are shown next and the intermediate images S2 are shown last. Other arranging techniques may be used.

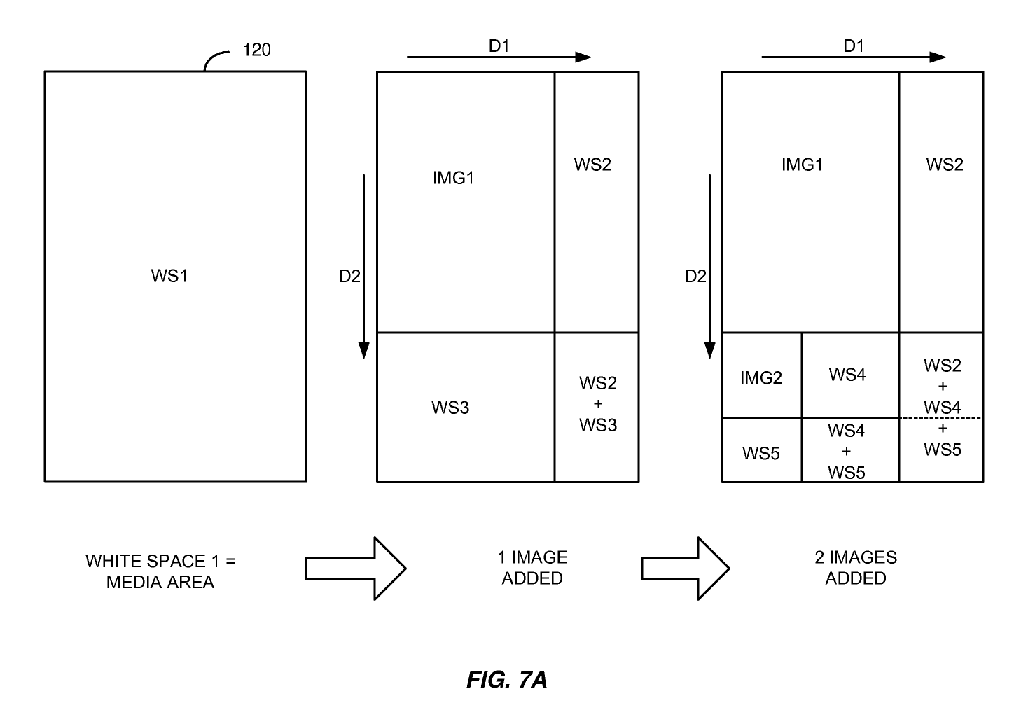

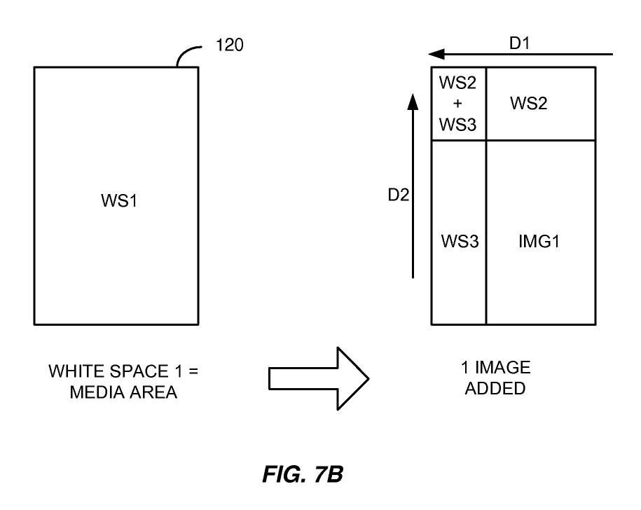

Once the images are arranged as desired (e.g., using a technique such as those shown in FIG. 5), the images 115 are positioned within the media areas 120. FIG. 6 shows that a first image (size S3) is selectively added to a first media area 120A. Thus, the first image occupies a predetermined region of the media area 120A, leaving other regions of the media area 120A empty. These empty regions are referred to herein as white spaces. FIG. 7A shows a schematic representation of how an individual media area 120 may be subdivided multiple times into image areas and white space areas. Initially, a media area 120 is empty and therefore includes a single white space WS1. In the illustrated example, an image IMG1 is placed into the upper left corner of the white space WS1. The image may be positioned in other corners of the white space WS1. For example, FIG. 7B shows an image IMG1 positioned in the lower right corner of the white space WS1.

Once an image IMG1 is added to the initial white space WS1, the image arranging program 40 replaces the portion of the original white space area WS1 not occupied by the image IMG1 with two white space areas WS2, WS3. White space WS2 represents the empty space remaining in the original white space W1 in direction D1 after the image IMG1 is placed. Similarly, white space WS3 represents the empty space remaining in the original white space W1 in direction D2 after the image IMG1 is placed. These white space areas WS2, WS3 are added to an “unoccupied” list of available white space areas. That is, the unoccupied white space areas WS2, WS3 are candidates for receiving subsequent images. Note that white space areas WS2 and WS3 overlap in the region labeled WS2+WS3. Accordingly, when the image arranging program 40 attempts to place an image in either of these white space areas WS2, WS3, the shared area WS2+WS3 is 20 considered “available” for both white space areas WS2, WS3.

Next, FIG. 7A shows a second image IMG2 inserted into white space area WS3. Accordingly, white space area WS3 is further subdivided in the IMG2 placeholder and two new white space areas WS4, WS5. As before, the newly added white space areas WS4, WS5 overlap in a first shared area labeled WS4+WS5. Further, the original shared area WS2+WS3 is now shared by all three white space areas WS2, WS4, WS5 and is labeled WS2+WS4+WS5 accordingly.

There are special cases where two white space areas WS2, WS3 may not result upon adding an image IMG1. In one case, the white space WS1 and the image IMG1 are substantially the same size. Consequently, there would be zero white space to add to the “unoccupied” list. In another case, either the length or width of the image IMG1 substantially match the length or width of the white space WS1. This scenario is illustrated in FIG. 7C. Specifically, the original white space WS1 is subdivided into an added image region IMG1 and a white space WS2. The image region IMG1 includes a substantially similar height in direction D2. Therefore, there is no white space in this direction. The newly created white space occupies the region of the original white space WS1 that is not filled by the image IMG1 in the direction D1.

In one implementation, the image arranging program 40 may refrain from establishing a white space in a given white space area if the area remaining after an image is placed is below a predetermined, possibly adjustable, threshold. For example, if less than about an inch (or other smaller or larger dimension) of space remains in a given direction in a white space area, the image arranging program 40 may decide that subsequent images will not likely fit in the remaining area and will not create an unoccupied white space in that direction. This scenario is illustrated in FIG. 7D. In the depicted example, the image IMG1 fills much, but not all of the original white space WS1 in the direction D1. In fact, the left over dimension L is less than a predetermined threshold T1. Accordingly, an empty space remains (to the right of the image in this example) in direction D1. By comparison, the image IMG1 fills less of the original white space WS1 in the direction D2. In this direction D2, the left over dimension L is greater than a predetermined threshold T2. Accordingly, an unoccupied white space WS2 is created (below the image in this example) in direction D2. Notably, the thresholds T1, T2 in each direction D1, D2 may be the same or different.

Those skilled in the art will comprehend that the respective image and white space locations and sizes may be defined through coordinate locations, object definitions, or other representations. Furthermore, each image may be bounded by finite margins, such as a quarter inch border, that are added to the effective area of the image. That is, for an image that is M inches wide by N inches high, the image spaces described herein may include a border dimension so that the overall image space (e.g., IMG1, IMG2) measures M+B1 by N+B2, where B1 and B2 represent borders in directions D1 and D2.

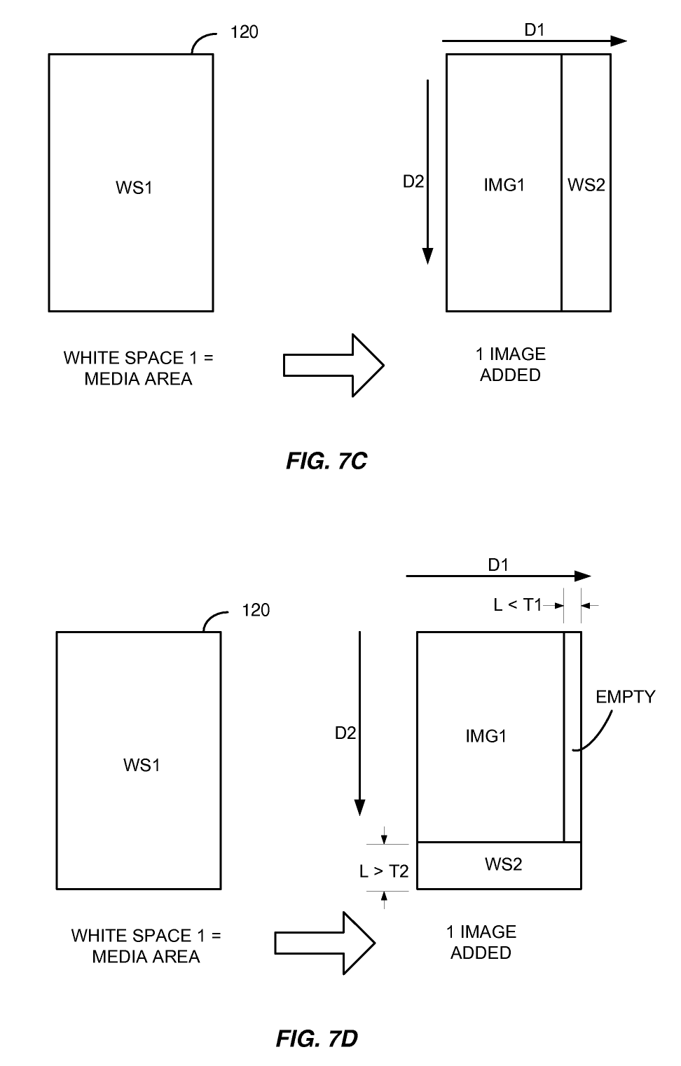

Generally, the image arranging program 40 attempts to place each image 115 into an available white space area in a media area 120, either in Landscape or Portrait orientation. Those skilled in the art will recognize the terms Landscape and Portrait as terms of art identifying the orientation of an image. Generally, “Landscape” refers to the orientation of an image such that the shorter side runs from top to bottom while “Portrait” refers to the orientation of an image such that the shorter side runs from side to side. These rotations are generally perpendicular to each other. It should be understood that these and other rotations, including rotations of different angles, are certainly permissible. If the image arranging program 40 cannot insert an individual image 115 into an available white space area, the program 40 moves to the next unoccupied white space area. If there are no more available white space areas in a current media area 120, the program 40 creates a new media area 120 and begins the insertion process again for that new media area 120. This process is depicted graphically in the flow diagram shown in FIG. 8.

The image arranging program 40 begins at step 800 and initially sorts the images (step 802) as depicted by the examples shown in FIG. 5. The program 40 then determines (step 804) if the image area will fit in the media area. If the image is too large, the program removes (step 806) the image from the list of images to be printed. If the image does fit, the program proceeds to create (step 808) a new media area. The program 40 then verifies (step 810) that there is at least one unoccupied white space in the media area. In the case of a new media area, there will be one white space area occupying the media area. The program 40 returns to this verification step 810 multiple times and if there are no available white spaces, a new media area is created in step 808. Otherwise, if there are available white spaces, the program 40 proceeds to check whether the current image area will fit in a current unoccupied white space (step 812). If the image does not fit, the program 40 attempts to rotate the image to a different orientation to determine if the image will otherwise fit. In one embodiment, the image is rotated from landscape to portrait (or vice-versa) to see if the rotated image will fit in the current unoccupied white space. In one embodiment, the image is rotated some angle other than 90 degrees. To that end, the program 40 will check to see if the image has been previously rotated (step 814). This status may be determined with a flag, such as a bit value in a register (not shown) or other means associated with the images in the sorted image list. If the image has not been previously rotated, the program rotates the image 90 degrees or some other angle (step 816) and attempts to fit the rotated image into the same unoccupied white space (step 812). If the image still does not fit, the program 40 will ultimately proceed to a next available white space as determined in step 810 to see if the current image can fit in another available white space in the media area. Though not shown in FIG. 8, the image rotation flag may be reset at this point to allow for image rotation in another available white space. If an image (rotated or not) fits in a current unoccupied white space, the image is added (step 818) to the white space in the media area and the program determines if there are more images to be placed (step 820). If there are additional images, the program 40 proceeds to the next image (step 822) and determines whether this next image will fit in available white spaces in the media area at step 810 as previously described. Otherwise, if all images have been placed, the program 40 terminates (step 824).

As described, the image arranging program 40 attempts to fit an image in an unoccupied white space in an original and rotated orientation before proceeding to a next unoccupied white space. In an alternative approach, the image arranging program 40 may attempt to position an image in each unoccupied white space before rotating the image and subsequently trying to fit the rotated image into each unoccupied white space. Those skilled in the art will comprehend other possible iterations that will attempt to fit each image in each unoccupied white space in both original and rotated orientations.

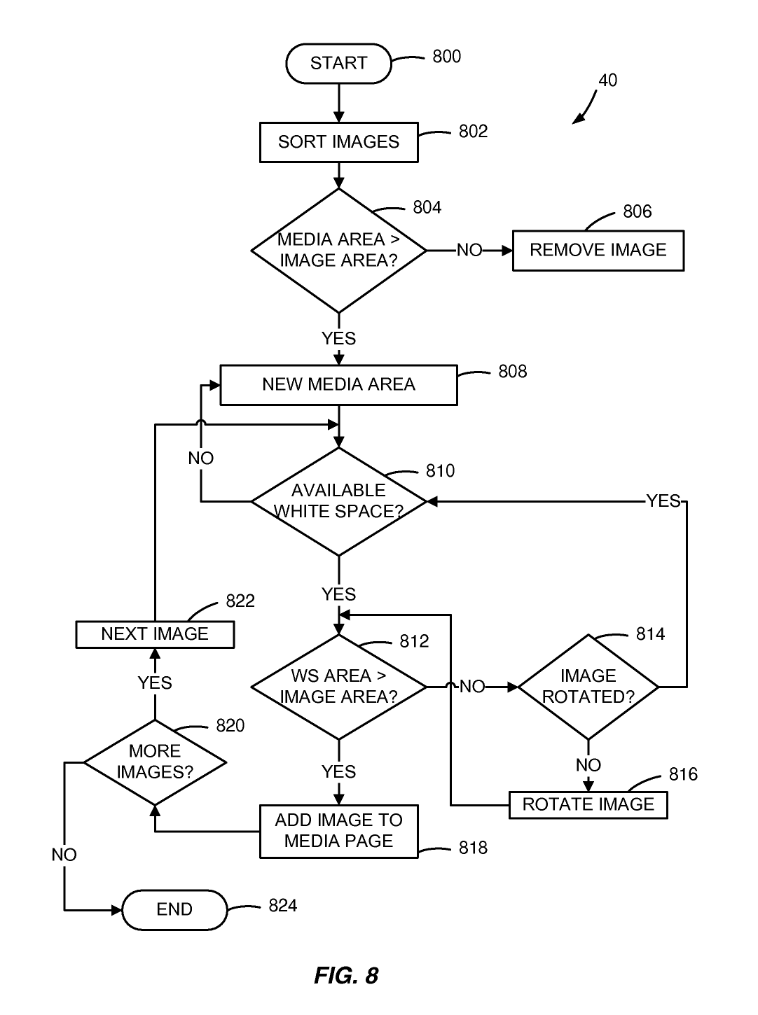

FIGS. 9-11 show an exemplary implementation of the image arranging program 40 where images 115 are systematically positioned on media areas 120A, 120B. After the first image (size S3) is selectively added to a first media area 120A, the image arranging program 40 determines that the intermediate size images S2 are too big to fit in the remaining areas of the first media area 120A. Accordingly, as FIG. 9 shows, the image arranging program 40 places the small size images S3 in the remaining areas of the first media area 120A. Note that some of the small images S3 are rotated 90 degrees as described above. At this point, the first media area 120A is substantially filled and the image arranging program creates a new media area 120B in which the intermediate size images S2 are subsequently placed (see FIGS. 10 and 11).

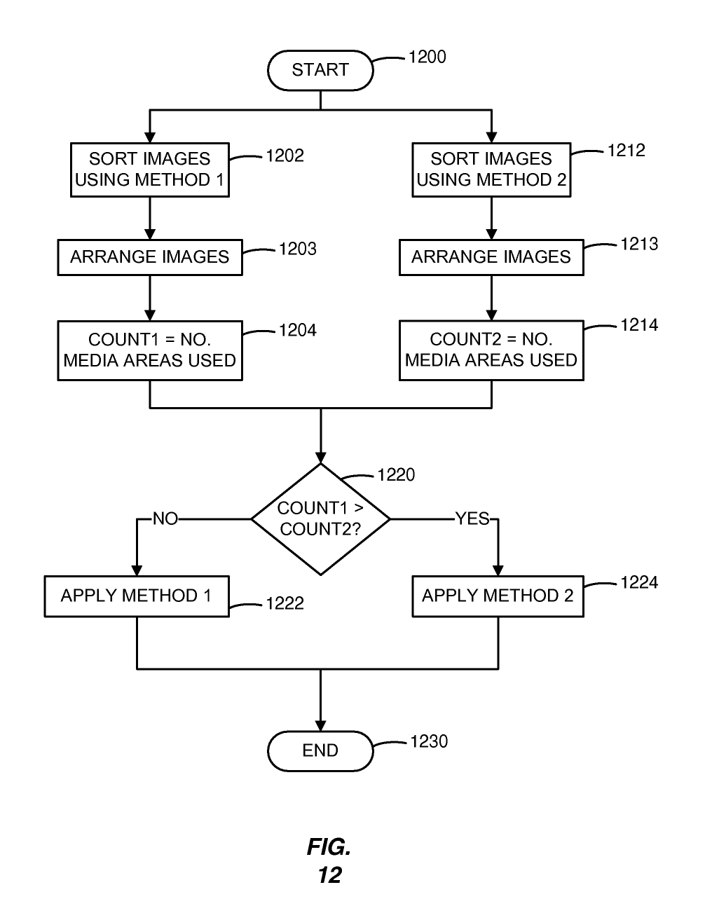

The image arranging program 40 may use several different sorting techniques as depicted by the examples shown in FIG. 5 to determine which method yields an optimal use of media areas. For example, one sorting method may require fewer media areas than another. Accordingly, FIG. 12 illustrates a flow diagram of one exemplary process for determining this optimization. The process begins with parallel or sequential implementation of the arranging program shown in FIG. 8. Each implementation uses a different sorting method (steps 1202, 1212). Then, the images are arranged (steps 1203, 1213) as described above. Once all images are arranged on media areas for each sorting method, the total number of media areas used are counted (step 1204, 1214). The respective media area counts COUNT1, COUNT2 are compared (step 1220). If the first sorting method results in the same or fewer used media areas, then this sorting method is used (step 1222). Conversely, if the second sorting method results in fewer media areas, then the second sorting method is used (step 1224).

The present invention may be carried out in other specific ways than those herein set forth without departing from the scope and essential characteristics of the invention. For example, while embodiments described above have contemplated a program that is executable on a computer 30 at which a user wishes to process images. In other embodiments, the image arranging techniques may be implemented partly or completely at remote locations on other machines, such as at the multifunction device 10 on which the images are printed or at a web server from which the images are obtained. In other embodiments, the image arranging techniques and image arranging program 40 may be implemented partly or completely at on servers in a local or wide area network. The present embodiments are, therefore, to be considered in all respects as illustrative and not restrictive, and all changes coming within the meaning and equivalency range of the appended claims are intended to be embraced therein.

What is claimed is:

1. A method of arranging a first image and a second image into a media area, the method comprising:
positioning the first image within a first white space of the media area;
subdividing the first white space into a first image space in which the first image is positioned, a second white space, and a third white space;
creating the second white space in a region of the first white space not occupied by the first image in a first direction;
creating a third white space in a region of the first white space not occupied by the first image in a second direction; and
positioning the second image within the second white space if the second image is not larger than the second white space in both the first and second directions.

2. The method of claim 1 further comprising rotating the second image if the second image is larger in either of the first and second directions than the second white space.

3. The method of claim 2 further comprising positioning the rotated second image within the second white space if the rotated second image is not larger than the second white space in both the first and second directions.

4. The method of claim 1 further comprising positioning the second image within the third white space if the second image is larger in either of the first and second directions than the second white space.

5. The method of claim 4 further comprising rotating and positioning the rotated second image within the third white space if the rotated second image is not larger than the third white space in both the first and second directions.

6. The method of claim 1 further comprising creating the second white space in the region of the first white space not occupied by the first image in the first direction if a difference in size between the first image and the first white space in the first direction exceeds a predetermined threshold.

7. The method of claim 1 further comprising creating the third white space in the region of the first white space not occupied by the first image in the second direction if a difference in size between the first image and the first white space in the second direction exceeds a predetermined threshold.

8. The method of claim 1 wherein the first and second directions are substantially perpendicular to each other.

9. A method of arranging a plurality of images into a minimum number of media areas, the method comprising:
positioning a first image within a first white space of a first media area;
positioning a second image within an unoccupied second white space of the first media area if the second image in a first orientation spatially fits within the second white space;
if the second image in the first orientation does not spatially fit within the second spatial area, rotating the second image to a second orientation and positioning the rotated second image within the second white space if the second image in the second orientation spatially fits within the second white space; and
if the second image in the first and second orientations does not spatially fit within the second spatial area, creating a second media area and positioning the second image within a third white space of the second media area.

10. The method of claim 9 further comprising sorting the plurality of images by spatial size.

11. The method of claim 9 further comprising creating the second spatial area in a region of the first spatial area not occupied by the first image if a difference in size between the first image and the first spatial area exceeds a predetermined threshold.

12. The method of claim 9 further comprising positioning a third image within the second white space if the third image rotated in a third or a fourth orientation spatially fits within the second white space.

13. The method of claim 9 further comprising creating a third spatial area in a region of the second spatial area not occupied by the third image if a difference in size between the third image and the second spatial area exceeds a predetermined threshold.

14. The method of claim 9 wherein the second white space comprises a first and a second region, the first region located in a portion of the first white space not occupied by the first image in a first direction, the second region located in a portion of the first white space not occupied by the first image in a second direction.

15. The method of claim 14 wherein the first and second regions overlap.

16. The method of claim 9 further comprising creating a third spatial area in a region of the second spatial area not occupied by the second image if a difference in size between the second image and the second spatial area exceeds a predetermined threshold.

17. A method of arranging a plurality of images into a minimum number of media areas, the method comprising:
sorting the plurality of images into a first image set using a first ordering scheme;
sorting the plurality of images into a second image set using a second ordering scheme;
arranging the first image set in sequence in a first total number of media areas;
arranging the second image set in sequence in a second total number of media areas; and
selecting the first ordering scheme for arranging the plurality of images into a minimum number of media areas if the first total number of media areas is less than the second total number of media areas.

18. The method of claim 17 wherein the step of sorting the plurality of images into a first image set using a first ordering scheme comprises sorting the images in order of increasing spatial size.

19. The method of claim 18 wherein the step of sorting the plurality of images into a second image set using a second ordering scheme comprises sorting the images in order of decreasing spatial size.

20. The method of claim 17 wherein the step of sorting the plurality of images into a first image set using a first ordering scheme comprises sorting the images in order of decreasing spatial size.

21. The method of claim 20 wherein the step of sorting the plurality of images into a second image set using a second ordering scheme comprises sorting the images in order of increasing spatial size.

22. The method of claim 17 wherein the steps of respectively arranging the first and second image sets in sequence in a first and a second total number of media areas comprises creating a list of unoccupied white areas within each of the first and second total number of media areas and sequentially positioning each of the plurality of images in the first and second image sets into one of the unoccupied white areas if the image spatially fits in the unoccupied white space in either of a first original orientation or a second rotated orientation.

23. The method of claim 22 wherein upon positioning one of the plurality of images into one of the unoccupied white areas, further subdividing the one of the unoccupied white areas into a first image space in which the one of the plurality of images is positioned, a second white space, and a third white space.
